(19) United States
(12) Patent Application Publication
(10) Pub. No.: US 2007/0118862 A1
(43) Pub. Date: May 24, 2007

(54) Home appliance with MP3 player

(75) Inventors: Seong Hae Jeong, Changwon-si (KR); Byung Hwan Ahn, Gimhae-si (KR); Hyeok Deok Kim, Changwon-si (KR); Hung Myong Cho, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/477,796

(22) Filed: Jun. 30, 2006

(30) Foreign Application Priority Data
Jun. 30, 2005 (KR) 10-2005-57660
Jun. 30, 2005 (KR) 10-2005-57665

(51) Int. Cl. H04N 7/173; H04N 7/16; H04N 7/18; H04N 11/00; H04N 7/00

(52) U.S. Cl. 725/80; 725/133; 725/141; 725/153; 348/552

(57) ABSTRACT

Disclosed herein is a home appliance with an MP3 player which is capable of playing back digital contents of the MP3 player. The home appliance includes the MP3 player adapted for storing contents, and a washing device for washing or drying clothes. The washing device is connectable with the MP3 player, and has a communication function with the MP3 player to play back the contents stored in the MP3 player.

This application claims the benefit of Korean Patent Application Nos. 10-2005-0057660 and 10-2005-0057665, filed on Jun. 30, 2005, which are hereby incorporated by reference as if fully set forth herein.

### BACKGROUND OF THE INVENTION

1. Field of the Invention

The present invention relates to a home appliance, and more particularly, to a home appliance with an MP3 player which is capable of playing back digital contents of the MP3 player.

2. Discussion of the Related Art

Generally, a washing machine is an electric home appliance, which is most widely used in homes to remove contaminants attached to laundry such as clothes by utilizing a softening action of detergent, a frictional action of wash water flows resulting from a rotational action, an impact of the wash water flows applied to the laundry, etc.

For such washing machines, products of various washing types, for example, a pulsator type, agitator type, drum type, etc. are commercially available. Such washing machines may also be classified into a separation type and a full automation type in terms of whether or not washing and spin-drying tubs are separated from each other.

For most washing machines, the user uses the washing machines by properly setting washing conditions, such as a washing time, rinsing time and spin-drying time, according to the materials or amount of laundry.

A plurality of washing course programs are pre-stored in a memory so that they may be selectively utilized by the user to perform automatic washing for the user's convenience.

For example, a variety of washing course programs, such as centrifugal washing, high-concentration washing, prewashing, vibration washing, annealing washing and wool washing, may be pre-stored in the memory so that the user can simply and conveniently select a desired washing course to execute the automatic washing.

Besides, a drying machine is a home appliance which has a similar structure and is used in a similar manner.

Meanwhile, nowadays, customer concerns and desires for upgradation of home appliances are increasing. For this reason, in spite of the repeated development of home appliances for the user's convenience as mentioned above, it is next to impossible to expect that the customers will be satisfied with only the existing home appliances.

Recently, in a home appliance field, a multifunctionalization to integrate composite functions in one product is being attempted, as well as a high functionalization to improve the original function of the product.

These attempts are contrary evidence that the home appliance market has been saturated, but results of efforts to provide more excellent and convenient products through continuous technical development.

However, for a washing apparatus, such as a washing machine or drying machine, the user requires a higher technique than is currently possible, resulting in an increase in product cost of the washing apparatus and, in turn, a limitation in universal use thereof. In this regard, at present, there is a need for a new technique capable of readily acquiring various information even at low cost.

### SUMMARY OF THE INVENTION

Accordingly, the present invention is directed to a home appliance with an MP3 player that substantially obviates one or more problems due to limitations and disadvantages of the related art.

An object of the present invention is to provide a home appliance with an MP3 player which can be universally used at a lower cost.

Another object of the present invention is to provide a home appliance with an MP3 player which can significantly increase customer satisfaction with a multifunctionalization thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a home appliance with an MP3 player comprises: the MP3 player adapted for storing contents; and a washing device for washing or drying clothes, the washing device being connectable with the MP3 player and having a communication function with the MP3 player to play back the contents stored in the MP3 player.

The washing device and the MP3 player may perform data communication therebetween on the basis of a serial communication protocol, such as a universal serial bus (USB) protocol.

Preferably, the washing device comprises: an input/output terminal for physically connecting the washing device with the MP3 player for data communication with the MP3 player; a connector for physically connecting the washing device with the MP3 player to receive an audio signal outputted from the MP3 player; a key input unit for inputting washing or drying mode conditions and a control command for the MP3 player from a user; a display unit for displaying information regarding an operation of a washing or drying mode and information regarding an operation of the MP3 player; an audio output unit for outputting a mode state in the form of an audio signal and the audio signal from the MP3 player received through the connector; and a controller for, in response to a control of the user through the key input unit, controlling the operation of the washing or drying mode, and controlling the operation of the MP3 player by performing the data communication with the MP3 player through the input/output terminal.

The washing device may further comprise a power-supply for supplying a desired voltage to the MP3 player through the input/output terminal.

The washing device may further comprise an Internet-connectable communication unit.

The key input unit may comprise a key panel for control of the washing device, and a key panel for control of the MP3 player.

The controller may provide a graphic user interface (GUI) for control of the MP3 player through the display unit.

Preferably, the MP3 player comprises: a first connector for physically connecting the MP3 player to the washing device to receive a control signal transmitted from the washing device and a voltage supplied therefrom; a second connector for physically connecting the MP3 player to the washing device to output an audio signal to the washing device; a power input unit for receiving the voltage supplied through the first connector and supplying desired voltages to respective components of the MP3 player; a memory for storing various digital contents; and an MP3 controller for outputting the digital contents stored in the memory to the washing device through the first or second connector in response to a control signal inputted from the washing device through data communication with the washing device.

Preferably, the MP3 controller comprises a decoder for converting a format of an audio signal among the digital contents stored in the memory into a predefined format.

The MP3 player may further comprise an amplifier for amplifying an audio signal among the digital contents stored in the memory to a predetermined level and outputting the amplified audio signal to the second connector.

The MP3 player may further comprise an audio cable for connecting the second connector to the washing device to output the audio signal to the washing device through the second connector.

The MP3 player may further comprise a voice recorder for receiving an external input voice signal and transferring it to the memory.

In another aspect of the present invention, a home appliance with an MP3 player comprises: the MP3 player adapted for storing contents; a washing device for washing or drying clothes; and a monitor device for remotely controlling an entire operation of the washing device or monitoring a washing or drying state of the washing device through communication with the washing device, the monitor device having a data communication function with the MP3 player to play back the contents stored in the MP3 player.

The monitor device and the MP3 player may perform data communication therebetween on the basis of a serial communication protocol, such as a USB protocol.

Preferably, the monitor device comprises: a communication unit for transmitting a control command to the washing device or receiving state information of the washing device therefrom through power line communication with the washing device; an input/output terminal for physically connecting the monitor device with the MP3 player for data communication with the MP3 player; a key input unit for inputting a control command for the washing device or MP3 player from a user; a display unit for displaying the state information of the washing device and information regarding an operation of the MP3 player; an audio output unit for outputting the state information of the washing device and an audio content inputted from the MP3 player; and a monitor controller for controlling the operation of the washing device or MP3 player in response to the control command from the user by performing the power line communication with the washing device or the data communication with the MP3 player.

The communication unit may be a communication module using the power line communication.

The input/output terminal may be a USB port which physically connects the monitor device with the MP3 player.

The key input unit may comprise a key panel for control of the monitor device, and a key panel for control of the MP3 player.

The monitor controller may provide a GUI for control of the MP3 player through the display unit.

Preferably, the MP3 player comprises: a connector for physically connecting the MP3 player to the monitor device for data communication with the monitor device; a memory for storing various digital contents; and an MP3 controller for outputting the digital contents stored in the memory to the monitor device in response to a control signal inputted from the monitor device through the data communication with the monitor device.

Preferably, the MP3 controller comprises a decoder for converting a format of an audio signal among the digital contents stored in the memory into a predefined format.

The MP3 player may further comprise an amplifier for amplifying an audio signal among the digital contents stored in the memory to a predetermined level and outputting the amplified audio signal to the connector.

The MP3 player may further comprise a voice recorder for receiving an external input voice signal and transferring it to the memory.

The aforementioned home appliance with the MP3 player according to the present invention has effects as follows.

Firstly, the MP3 player can be connected to the home appliance, thereby significantly increasing customer satisfaction with a multifunctionalization of the home appliance.

Secondly, an audio signal from the MP3 player can be played back through the audio output unit, and various information associated with the home appliance can be downloaded using the MP3 player. Therefore, the home appliance can be used more universally.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 and FIG. 2 are perspective views showing a home appliance with an MP3 player according to a first embodiment of the present invention;

FIG. 3 is a block diagram showing the configurations of the MP3 player and a washing machine body according to the first embodiment of the present invention;

FIG. 4 is a perspective view showing a home appliance with an MP3 player according to a second embodiment of the present invention; and

FIG. 5 is a block diagram showing the configurations of the MP3 player and a monitor device according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

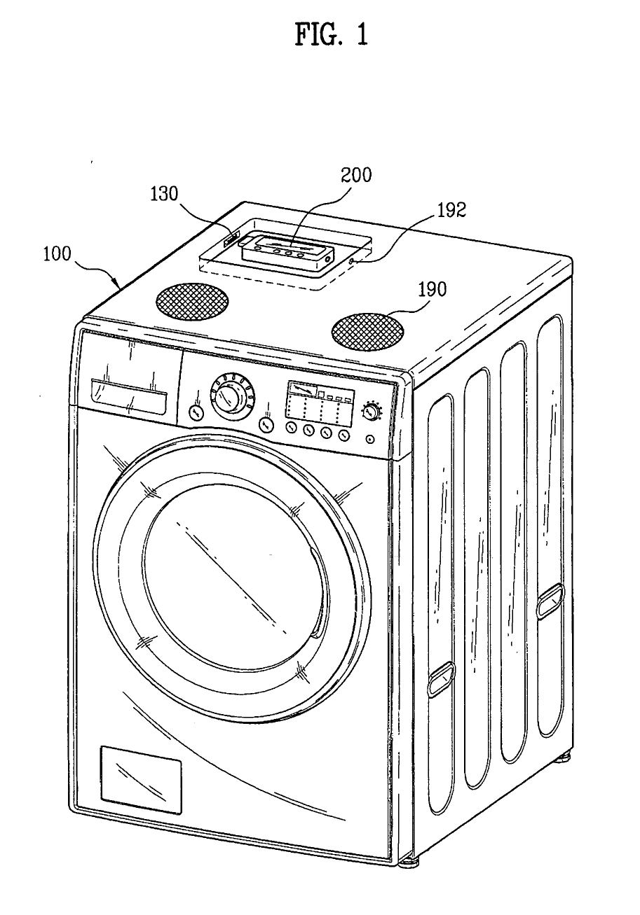

A home appliance with an MP3 player according to a first embodiment of the present invention will hereinafter be described with reference to FIG. 1 to FIG. 3.

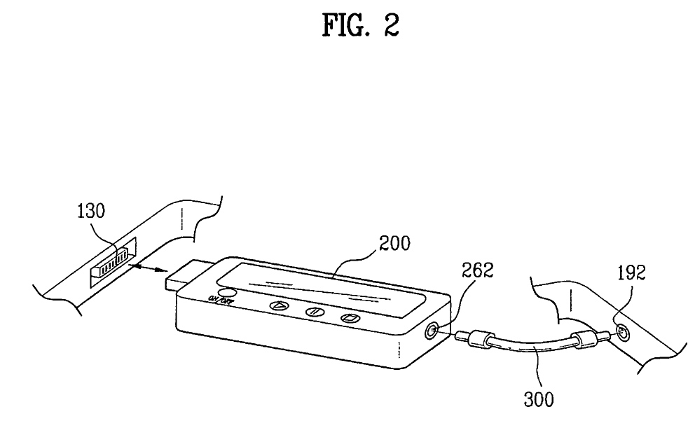

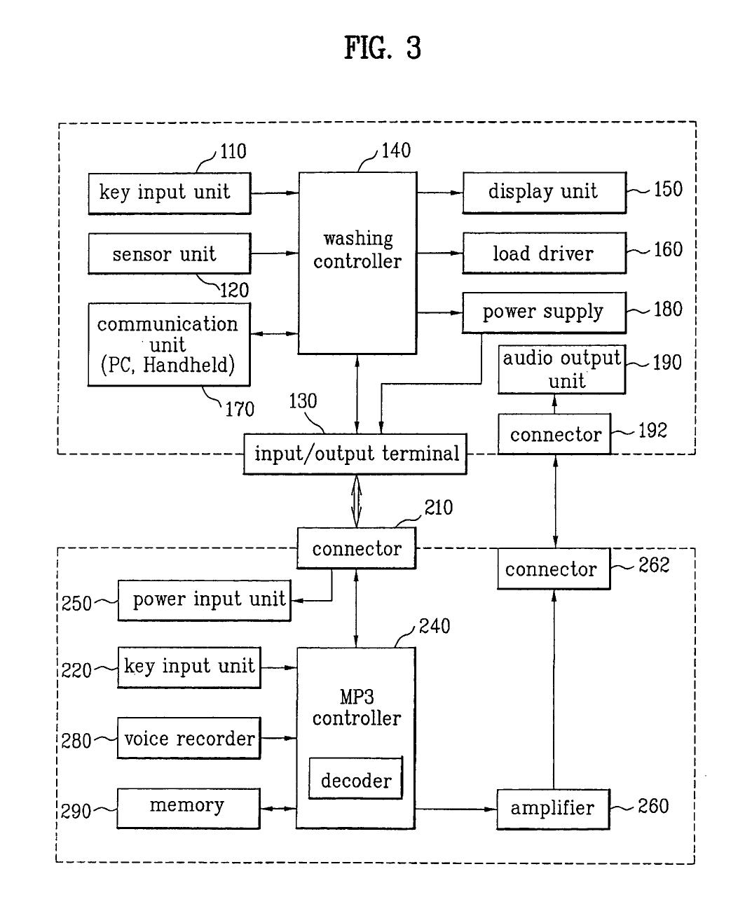

FIG. 1 and FIG. 2 are perspective views showing the home appliance, for example, a washing machine, with the MP3 player according to the first embodiment of the present invention, and FIG. 3 is a block diagram showing the configurations of the MP3 player and a washing machine body according to the first embodiment.

The washing machine according to the first embodiment comprises an MP3 player 200 for storing and playing back a digital content of an MP3 file, and a washing machine body 100 for performing a washing mode by a rotational action of a drum therein. The washing machine body 100 is connectable with the MP3 player 200.

As shown in FIG. 2, the washing machine body 100 preferably includes an input/output terminal 130 connectable with a connector 210 of the MP3 player 200.

That is, the input/output terminal 130 is a kind of connector that physically connects the washing machine body 100 and the MP3 player 200 with each other. The connector 210 of the MP3 player 200 is coupled to the input/output terminal 130.

Further, the washing machine body 100 and the MP3 player 200 preferably include connectors 192 and 262 for connection of an audio cable 300 therebetween for input/output of an audio signal, respectively.

Referring to FIG. 3, the washing machine body 100 includes a key input unit 110 for inputting washing mode conditions and a control command for the MP3 player 200 from the user, a sensor unit 120 for sensing various operation states while the washing mode is performed, a load driver 160 for driving loads necessary for the washing mode according to the washing mode conditions inputted from the user and the sensed operation states, a display unit 150 for displaying information regarding the operation of the washing mode and information regarding the operation of the MP3 player 200, and a washing controller 140 for controlling the operation of the washing mode and, when the MP3 player 200 is connected to the washing machine body 100 through the input/output terminal 130, controlling the operation of the MP3 player 200 through data communication with the MP3 player 200.

In particular, the washing machine body 100 includes an audio output unit 190 for outputting a washing state in the form of an audio signal and an audio signal outputted from the MP3 player 200.

The audio output unit 190 is preferably installed in the side or top plate of a cabinet constituting the outer appearance of the washing machine body 100.

That is, when the connector 262 of the MP3 player 200 is connected to the connector 192 of the washing machine body 100 via the audio cable 300, the audio signal outputted from the MP3 player 200 can be played back through the audio output unit 190 installed in the washing machine body 100.

The washing machine body 100 further includes a communication unit 170 which is a personal terminal (a personal computer (PC), handheld device or the like) capable of performing Internet communication. The communication unit 170 enables the user to use, over the Internet, a variety of services including downloading washing course programs.

The display unit 150 includes a liquid crystal display (LCD) to display the operation information of the washing mode and the operation information of the MP3 player 200.

The key input unit 110 is adapted to receive a control command signal based on a key operation of the user and transfer it to the washing controller 140. A key panel for control of the washing machine body 100 and a key panel for control of the MP3 player 200 are together provided in the key input unit 110.

A power supply 180 acts to receive a main voltage and supply desired voltages to all components of the washing machine body 100, and a desired voltage to the MP3 player 200 through the input/output terminal 130.

The washing controller 140 is equipped with an application program to perform the data communication with the MP3 player 200, as well as to control the operations of all components associated with the washing mode.

Preferably, the washing controller 140 performs the data communication with the MP3 player 200 on the basis of a serial communication protocol, such as a universal serial bus (USB) protocol.

The MP3 player 200 is a typical portable digital audio player, and includes the connector 210, a key input unit 220, a power input unit 250, a voice recorder 280, a memory 290, an amplifier 260, and an MP3 controller 240.

The connector 210 is coupled to the input/output terminal 130 of the washing machine body 100 to perform transmission and reception of data. The connector 210 also acts to transfer the voltage supplied from the power supply 180 of the washing machine body 100 to the power input unit 250 of the MP3 player 200.

The power input unit 250 functions to receive the voltage supplied from the power supply 180 of the washing machine body 100 and supply desired voltages to respective components of the MP3 player 200.

The MP3 controller 240 is equipped with an application program to communicate with the application program installed in the washing controller 140 of the washing machine body 100, as well as to control the operations of the respective components of the MP3 player 200.

Preferably, the MP3 controller 240 performs the data communication with the washing machine body 100 on the basis of the serial communication protocol such as the USB protocol.

The MP3 controller 240 includes a decoder (not denoted by a reference numeral) for playing back a digital content of an MP3 file and digital to analog (D/A)-converting or analog to digital (A/D)-converting an audio signal.

When the MP3 player 200 is connected to an external personal terminal (for example, a PC) to download a desired content therefrom, the decoder performs a slave communication function on the USB protocol.

The amplifier 260 acts to amplify and output an analog audio signal from the decoder of the MP3 controller 240 to an appropriate level. The audio signal outputted from the amplifier 260 is transferred to the connector 262.

The voice recorder 280 functions to receive an external voice, convert it into an electrical analog signal and store the converted analog signal in the memory 290 via the MP3 controller 240.

The memory 290 is adapted to store digital contents downloaded from an external PC, etc., for example, MP3 files, language study files, recorded audio files, washing course programs, washing mode start/end sounds, and so forth.

A description will hereinafter be given of the operation of the washing machine with the MP3 player according to the first embodiment of the present invention, constructed as stated above.

First, if the user connects the MP3 player 200 to the input/output terminal 130 of the washing machine body 100, data communication is carried out between the washing machine body 100 and the MP3 player 200 according to the application programs installed in the washing controller 140 and MP3 controller 240.

The user selects a desired one of the contents stored in the MP3 player 200 by operating the key input unit 110 of the washing machine body 100, namely, the key panel for the control of the MP3 player 200, under the condition that the MP3 player 200 is connected to the washing machine body 100.

At this time, the user selects the desired content by operating the key panel while viewing a graphic user interface (GUI) displayed through the display unit 150 of the washing machine body 100.

Meanwhile, the MP3 controller 240 of the MP3 player 200 reads the content selected by the user, among the contents stored in the memory 290, through communication with the washing controller 140.

At this time, in the case where the content selected by the user is audio data, it is transferred from the memory 290 to the decoder of the MP3 controller 240 and then converted into an analog audio signal by the decoder.

The converted analog audio signal is amplified to an appropriate level by the amplifier 260 and then delivered to the connector 262.

Also, in the case where the connector 262 of the MP3 player 200 is connected to the connector 192 of the washing machine body 100 via the audio cable (for example, an earphone cable) 300, the amplified audio signal is transferred to the washing machine body 100 through the earphone cable 300 and then played back through the audio output unit 190.

At this time, the washing controller 140 may receive information regarding the content being currently played back through communication with the MP3 controller 240 and display the received content information through the display unit 150.

On the other hand, in the case where the content selected by the user is washing information such as a washing course program or washing mode start/end sound, not audio data, the MP3 controller 240 reads the selected content from the memory 290 and transmits the read content to the washing machine body 100 through the connector 210. At this time, the washing information content is transmitted to the washing controller 140 according to the serial communication protocol under the control of the MP3 controller 240.

Subsequently, under the control of the washing controller 140, the washing machine body 100 receives the washing information content from the MP3 player 200 through the input/output terminal 130 and stores the received washing information content in its internal memory.

For example, the user may-download a washing course program from an external PC to the MP3 player 200, connect the MP3 player 200 to the washing machine body 100 and then upload the downloaded washing course program from the MP3 player 200 to the washing machine body 100.

On the other hand, recently, with the increase in the living space of a house, a washing machine or drying machine (referred to hereinafter only as a “washing machine”) is on a trend of being installed and used in a separate place distant from the living space, such as the outdoors or the basement of the house.

In the case where a washing machine is installed away from the living space like this, the user has to frequently visit a place where the washing machine is installed, to control the washing machine or monitor the operation state thereof, resulting in an inconvenience to the user.

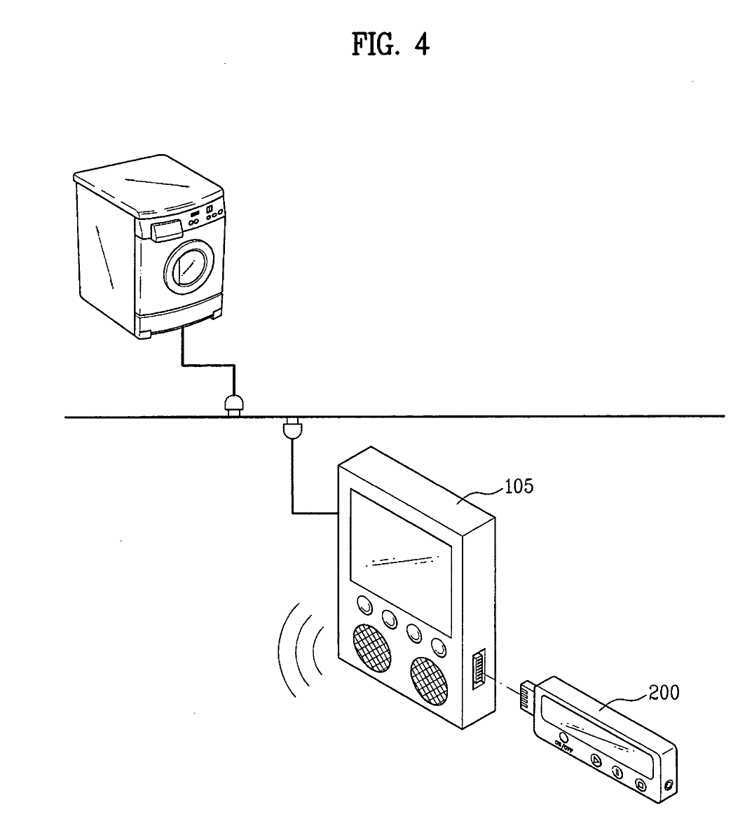

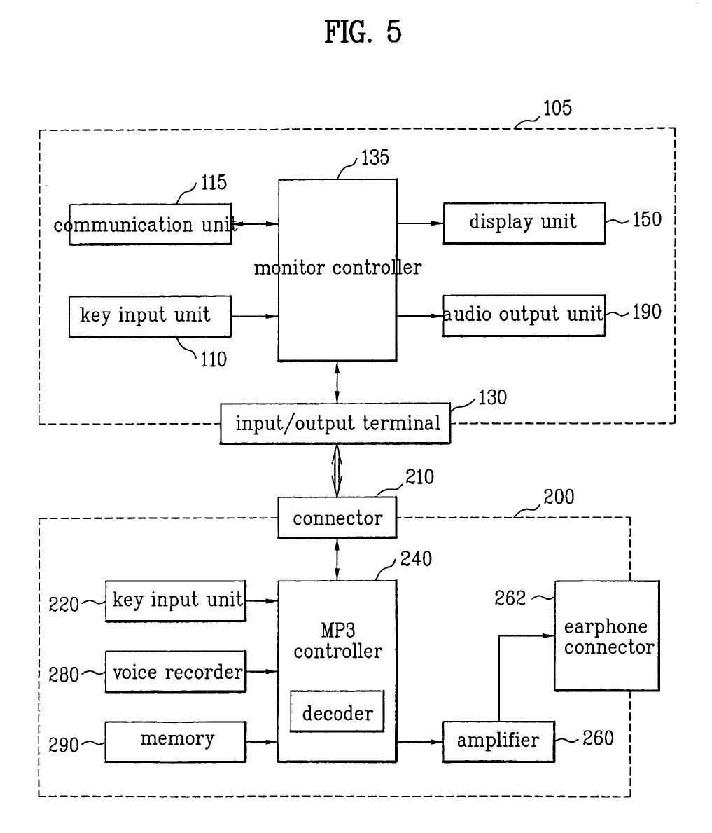

A home appliance with an MP3 player according to a second embodiment of the present invention will hereinafter be described with reference to FIG. 4 and FIG. 5.

FIG. 4 is a perspective view showing the home appliance, for example, a washing machine, with the MP3 player according to the second embodiment of the present invention, and FIG. 5 is a block diagram showing the configurations of the MP3 player and a monitor device according to the second embodiment of the present invention.

The washing machine according to the second embodiment comprises a washing machine body (not denoted by a reference numeral) for performing a washing mode by a rotational action of a drum therein, an MP3 player 200 for storing and playing back a digital content of an MP3 file, and a monitor device 105 connected to the washing machine body via a power line for remotely controlling the entire operation of the washing machine body or monitoring a washing state thereof. The monitor device 105 also has a communication function with the MP3 player 200 to play back the content stored in the MP3 player 200.

As shown in FIG. 5, the monitor device 105 preferably includes an input/output terminal 130 connectable with a connector 210 of the MP3 player 200.

That is, the input/output terminal 130 is a kind of connector that physically connects the monitor device 105 and the MP3 player 200 with each other. Preferably, the input/output terminal 130 is a USB port to which the connector 210 of the MP3 player 200 is coupled.

The MP3 player 200 includes an earphone connector 262 to which an earphone (not shown) is connectable.

Referring to FIG. 5, the monitor device 105 is means which is installed in the living space of the user to control and monitor a washing machine body installed in a separate place distant from the living space, such as the outdoors or the basement of a house, and includes a communication unit 115 for transmitting a control command to the washing machine body or receiving state information of the washing machine body therefrom through power line communication with the washing machine body, an input/output terminal 130 for connecting the monitor device with the MP3 player 200 for data communication with the MP3 player 200, a key input unit 110 for inputting control commands for the washing machine body and MP3 player 200 from the user, a display unit 150 for displaying the state information of the washing machine body and information regarding the operation of the MP3 player 200, and a monitor controller 135 for controlling the operation of the washing machine body or MP3 player 200 in response to the control commands from the user by performing the power line communication with the washing machine body or the data communication with the MP3 player 200.

In particular, the monitor device 105 includes an audio output unit 190 for outputting the state information of the washing machine body in the form of an audio signal and an audio signal outputted from the MP3 player 200.

The audio output unit 190 is preferably installed in the side or top plate of a cabinet constituting the outer appearance of the monitor device 105.

That is, when the MP3 player 200 is connected to the input/output terminal 130 of the monitor device 105, a content provided from the MP3 player 200 can be played back through the audio output unit 190 installed in the monitor device 105.

The display unit 150 includes a liquid crystal display (LCD) to display the state information of the washing machine body and the operation information of the MP3 player 200.

The key input unit 110 is adapted to receive a control command signal based on a key operation of the user and transfer it to the monitor controller 135. A key panel for control of the monitor device 105 and a key panel for control of the MP3 player 200 are together provided in the key input unit 110.

The monitor controller 135 is equipped with an application program to perform the data communication with the MP3 player 200, as well as the data communication with the washing machine body.

Here, the monitor controller 135 performs the data communication with the washing machine body on the basis of a power line communication protocol, and the data communication with the MP3 player 200 on the basis of a serial communication protocol, such as a universal serial bus (USB) protocol.

The communication unit 115 of the monitor device 105 is a communication module capable of performing the power line communication, for example, a power line modem. This communication unit 115 can perform the data communication with the washing machine body without using a network such as a gateway or a communication network such as the Internet.

The MP3 player 200 is a typical portable digital audio player, and includes a connector 210, a key input unit 220, a voice recorder 280, a memory 290, an amplifier 260, and an MP3 controller 240.

The connector 210 is coupled to the input/output terminal 130 of the monitor device 105 to perform transmission and reception of data.

The MP3 controller 240 is equipped with an application program to communicate with the application program installed in the monitor controller 135 of the monitor device 105, as well as to control the operations of respective components of the MP3 player 200.

Preferably, the MP3 controller 240 performs the data communication with the monitor device 105 on the basis of the serial communication protocol such as the USB protocol.

The MP3 controller 240 includes a decoder for playing back a digital content of an MP3 file and digital to analog (D/A)-converting or analog to digital (A/D)-converting an audio signal.

When the MP3 player 200 is connected to an external personal terminal (for example, a PC) to download a desired content therefrom, the decoder performs a slave communication function on the USB protocol.

The amplifier 260 acts to amplify and output an analog audio signal from the decoder of the MP3 controller 240 to an appropriate level. The audio signal outputted from the amplifier 260 is transferred to the earphone connector 262.

The voice recorder 280 functions to receive an external voice, convert it into an electrical analog signal and store the converted analog signal in the memory 290 via the MP3 controller 240.

The memory 290 is adapted to store digital contents downloaded from an external PC, etc., for example, MP3 files, language study files, recorded audio files, washing course programs, washing mode start/end sounds, and so forth.

A description will hereinafter be given of the operation of the washing machine with the MP3 player according to the second embodiment of the present invention, constructed as stated above.

First, if the user connects the MP3 player 200 to the input/output terminal 130 of the monitor device 105, data communication is carried out between the monitor device 105 and the MP3 player 200 according to the application programs installed in the monitor controller 135 and MP3 controller 240.

The user selects a desired one of the contents stored in the MP3 player 200 by operating the key input unit 110 of the monitor device 105, namely, the key panel for the control of the MP3 player 200, under the condition that the MP3 player 200 is connected to the monitor device 105.

At this time, the user selects the desired content by operating the key panel while viewing a graphic user interface (GUI) displayed through the display unit 150 of the monitor device 105.

Meanwhile, the MP3 controller 240 of the MP3 player 200 reads the content selected by the user, among the contents stored in the memory 290, through communication with the monitor controller 135.

At this time, the MP3 controller 240 reads the selected content from the memory 290 and uploads the read content to the monitor device 105 through the connector 210. Here, the read content is transmitted to the monitor controller 135 according to the serial communication protocol under the control of the MP3 controller 240.

Thereafter, the monitor device 105 receives the content from the MP3 player 200 through the input/output terminal 130 under the control of the monitor controller 135.

Here, in the case where the content received from the MP3 player 200 is audio data, the monitor controller 135 internally decodes the received content to convert it into an analog audio signal that can be outputted.

The audio signal converted by the monitor controller 135 is played back through the audio output unit 190 of the monitor device 105.

At this time, the monitor controller 135 may receive information regarding the content of the audio signal being currently played back through the audio output unit through communication with the MP3 controller 240 and display the received content information through the display unit 150.

On the other hand, in the case where the content received from the MP3 player 200 is washing information such as a washing mode start/end sound, not audio data, the monitor controller 135 stores the received washing information content in its internal memory. The washing information of the washing machine body, such as the washing mode start/end sound, can be changed using this washing information content.

For example, the user may download a desired washing information content from an external PC to the MP3 player 200, connect the MP3 player 200 to the monitor device 105 and then upload the downloaded washing information content from the MP3 player 200 to the monitor device 105.

Therefore, according to the present invention, the MP3 player can be connected to the home appliance, so that an audio signal stored in the MP3 player can be played back through the audio output unit of the home appliance, or various information associated with the home appliance can be downloaded using the MP3 player.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A home appliance with an MP3 player comprising:
the MP3 player adapted for storing contents; and
a washing device for washing or drying clothes, the washing device being connectable with the MP3 player and having a communication function with the MP3 player to play back the contents stored in the MP3 player.

2. The home appliance according to claim 1, wherein the washing device and the MP3 player perform data communication therebetween on the basis of a serial communication protocol, the serial communication protocol being a universal serial bus (USB) protocol.

3. The home appliance according to claim 1, wherein the washing-device comprises:
an input/output terminal for physically connecting the washing device with the MP3 player for data communication with the MP3 player;
a connector for physically connecting the washing device with the MP3 player to receive an audio signal outputted from the MP3 player;
a key input unit for inputting washing or drying mode conditions and a control command for the MP3 player from a user;
a display unit for displaying information regarding an operation of a washing or drying mode and information regarding an operation of the MP3 player;
an audio output unit for outputting a mode state in the form of an audio signal and the audio signal from the MP3 player received through the connector; and
a controller for, in response to a control of the user through the key input unit, controlling the operation of the washing or drying mode, and controlling the operation of the MP3 player by performing the data communication with the MP3 player through the input/output terminal.

4. The home appliance according to claim 3, wherein the washing device further comprises a power supply for supplying a desired voltage to the MP3 player through the input/output terminal.

5. The home appliance according to claim 3, wherein the washing device further comprises an Internet-connectable communication unit.

6. The home appliance according to claim 3, wherein the key input unit comprises a key panel for control of the washing device, and a key panel for control of the MP3 player.

7. The home appliance according to claim 3, wherein the controller provides a graphic user interface (GUI) for control of the MP3 player through the display unit.

8. The home appliance according to claim 1, wherein the MP3 player comprises:
a first connector for physically connecting the MP3 player to the washing device to receive a control signal transmitted from the washing device and a voltage supplied therefrom;
a second connector for physically connecting the MP3 player to the washing device to output an audio signal to the washing device;
a power input unit for receiving the voltage supplied through the first connector and supplying desired voltages to respective components of the MP3 player;
a memory for storing various digital contents; and
an MP3 controller for outputting the digital contents stored in the memory to the washing device through the first or second connector in response to a control signal inputted from the washing device through data communication with the washing device.

9. The home appliance according to claim 8, wherein the MP3 controller comprises a decoder for converting a format of an audio signal among the digital contents stored in the memory into a predefined format.

10. The home appliance according to claim 8, wherein the MP3 player further comprises an amplifier for amplifying an audio signal among the digital contents stored in the memory to a predetermined level and outputting the amplified audio signal to the second connector.

11. The home appliance according to claim 8, wherein the MP3 player further comprises an audio cable for connecting the second connector to the washing device to output the audio signal to the washing device through the second connector.

12. The home appliance according to claim 8, wherein the MP3 player further comprises a voice recorder for receiving an external input voice signal and transferring it to the memory.

13. A home appliance with an MP3 player comprising:
the MP3 player adapted for storing contents;
a washing device for washing or drying clothes; and
a monitor device for remotely controlling an entire operation of the washing device or monitoring a washing or drying state of the washing device through communication with the washing device, the monitor device having a data communication function with the MP3 player to play back the contents stored in the MP3 player.

14. The home appliance according to claim 13, wherein the monitor device and the MP3 player perform data communication therebetween on the basis of a serial communication protocol, the serial communication protocol being a USB protocol.

15. The home appliance according to claim 13, wherein the monitor device comprises:
a communication unit for transmitting a control command to the washing device or receiving state information of the washing device therefrom through power line communication with the washing device;
an input/output terminal for physically connecting the monitor device with the MP3 player for data communication with the MP3 player;
a key input unit for inputting a control command for the washing device or MP3 player from a user;
a display unit for displaying the state information of the washing device and information regarding an operation of the MP3 player;
an audio output unit for outputting the state information of the washing device and an audio content inputted from the MP3 player; and
a monitor controller for controlling the operation of the washing device or MP3 player in response to the control command from the user by performing the power line communication with the washing device or the data communication with the MP3 player.

16. The home appliance according to claim 15, wherein the communication unit is a communication module using the power line communication.

17. The home appliance according to claim 15, wherein the input/output terminal is a USB port which physically connects the monitor device with the MP3 player.

18. The home appliance according to claim 15, wherein the key input unit comprises a key panel for control of the monitor device, and a key panel for control of the MP3 player.

19. The home appliance according to claim 15, wherein the monitor controller provides a GUI for control of the MP3 player through the display unit.

20. The home appliance according to claim 13, wherein the MP3 player comprises:
a connector for physically connecting the MP3 player to the monitor device for data communication with the monitor device;
a memory for storing various digital contents; and
an MP3 controller for outputting the digital contents stored in the memory to the monitor device in response to a control signal inputted from the monitor device through the data communication with the monitor device.

21. The home appliance according to claim 20, wherein the MP3 controller comprises a decoder for converting a format of an audio signal among the digital contents stored in the memory into a predefined format.

22. The home appliance according to claim 20, wherein the MP3 player further comprises an amplifier for amplifying an audio signal among the digital contents stored in the memory to a predetermined level and outputting the amplified audio signal to the connector.

23. The home appliance according to claim 20, wherein the MP3 player further comprises a voice recorder for receiving an external input voice signal and transferring it to the memory.
